(19) United States
(12) Patent Application Publication
(10) Pub. No.: US 2020/0265527 A1
(43) Pub. Date: Aug. 20, 2020

(54) AGRONOMIC PRESCRIPTION PRODUCT

(71) Applicant: Growers Edge Financial, Inc., Johnston, IA (US)

(72) Inventors: William T. Rose, Johnston, IA (US); Norris Joseph Young, Johnston, IA (US); Samuel H. Bunz, Johnston, IA (US); Raymond Loren Naylor, Johnston, IA (US)

(21) Appl. No.: 16/277,019

(22) Filed: Feb. 15, 2019

(51) Int. Cl. G06Q 50/02; G06Q 40/08; A01B 79/00; A01G 7/00

(52) U.S. Cl. CPC G06Q 50/02; A01G 7/00; A01B 79/005; G06Q 40/08

(57) ABSTRACT

The agronomic prescription product provides a tool and a method to increase crop yield in a defined geographical area, by an amount greater than a specified percentage of a subset of that field's historical yield for that same crop. Specifically, the novel method provides a computer processor (hereafter, “Improved Processor” or “Improved Computer”) improved by the incorporation of an Agronomic Prescription Product which enables the Improved Processor to generate a “prescription” based on crop type, field type, soil conditions, and pest pressure in the field to increase yield by an amount related to historical yield and determined by the Improved Processor (Crop Performance Guarantee). The Improved Processor generates agronomic prescription recommendations tailored to the purpose of increasing crop and plant type yield a certain amount relative to historical yield, along with a guaranteed increase related to the actual yield (Crop Performance Guarantee), should that yield be lower than prescribed.

### FIELD OF INVENTION

The present invention relates to reducing risk related to growing crops, generally, and more specifically to a tool that employs an Agronomic Prescription Product to improve yield over historical yield.

### BACKGROUND OF THE INVENTION

Improved agricultural production methods have been and remain the focus of much effort. Crop insurance against a variety of perils that dramatically decrease the effect of those production methods has long been a staple for handling the risks associated with the investment required to plant, grow and harvest a crop. However, such insurance covers only a set yield level based on historical yield. Sustainably increasing production and efficiency across a number of years is the target of those improved agricultural methods. However, crop insurance coverage often does not cover the expected increase in yield at a level that reflects the result of these production methods. Crop insurance coverage is limited to the value of the crop based on the average of yield produced over years and even decades resulting in a coverage level that is latent with outdated technology. There is, therefore, a need for a tool or system that comprises a method that measurably improves yield over production history by combining historic and present collected data and testing geographically sourced plant health (generally overall healthy plant growth) analysis during the growing season and formulating contemporary, geographic specific recommendations accordingly. The method should consider yield of the producer relative to its history and relative to other geographically near producers and aim to increase relative yields and guarantee at least a portion of replacement cost against loss.

### BRIEF SUMMARY OF THE INVENTION

The innovation presented provides a tool and a method of providing an increase in crop yield in a particular field, county, province, or other defined geographical area which may be indicated or identified by one or more geospatial indicators (wherein “field” is a term used to designate a specific geographically located area which may be expressed in terms of geospatial indicators and area units such as, but not limited to, acres, hectares, and square feet), by an amount greater than a specified percentage of a subset of that field's historical yield for that same crop. Specifically, the novel method provides a computer processor (hereafter, “Improved Processor” or “Improved Computer”) improved by the incorporation of an Agronomic Prescription Product which enables the computer processor to generate recommendations or a “prescription” based on crop type, field type, soil conditions, and pest (refers to but not limited to insects and diseases) pressure in the field to increase yield by an amount related to historical yield and determined by the Improved Processor (Crop Performance Guarantee). The computer processor improved by the Agronomic Prescription Product generates agronomic prescription recommendations tailored to the purpose of increasing crop and plant type yield a certain amount relative to historical yield, along with a guaranteed increase related to the actual yield (Crop Performance Guarantee), should that yield be lower than prescribed. The prescription recommendations are geographic. In one embodiment, the Processor creates a map comprising overlays of the agronomic prescription recommendations on a field map, thereby providing coordinates for each recommendation. The computer Processor combined with the Agronomic Prescription Product comprises a tool for combining and periodically analyzing a large number of on-going data points for a particular field (a specific geographically located area) on which the method is employed including, for example, any one or more data points pertaining to seed, seed and crop protection, herbicides, pesticides, fungicides, macronutrients and micronutrients, and soil fertility. The Agronomic Prescription Product improves a computer processor so that it employs periodic, planned analysis of plant health from the field and the results of various tests made on the plant health, e.g., tissue sampling, pest infestation monitoring, drone monitoring and soil testing. The plant health analysis; infestation monitoring and soil testing will typically be performed at least once during mid-season growing period, and sometimes multiple times spaced apart to measure/monitor trends. To determine deficiencies, the Processor improved by the Agronomic Prescription Product compares sample data with standard or goal metrics specific to the crop and plant type by field, and perhaps relative to growth stage or other known conditions or statuses. Once deficiencies are determined, the Processor addresses any detected deficiencies; specifically, the Improved Computer comprising the Agronomic Prescription Product creates additional agronomic prescription recommendations for mid-season adjustments aimed to meet or exceed the method's yield guarantee relative to a measure of that field's historical average as compared to a county measure related to yield as a percentage on all geographic portions of that field. In particular, the data, (whether field-specific or more global or a combination of both), is used by the Processor improved by the Agronomic Prescription Product to generate an agronomic prescription which comprises recommendations specifically tailored to the crop and the plant type, and employs the plant health analysis results, by field or other geographic unit for which that historical average applies. When the Agronomic Prescription Product recommendations are followed by the customer and result in a yield increase at or above a predetermined yield level, then the customer markets as normal. However, if the yield does not reach the predetermined percentage level then the value of guaranteed replacement cost is calculated by the Improved Processor and paid. Without the Processor improved by the Agronomic Prescription Product and Crop Performance Guarantee, the expected increase in yield (and the investment required to meet the prescription requirements), could be a total loss in a catastrophic event. Further, without geographically specific prescription, inputs may be applied where they are not needed, and not applied where they are needed resulting in inefficiencies and loss. Such loss would not only include the loss in yield and input product costs per acre, but also the expense required to gather the requisite data and devise and generate an agronomic prescription plan or pay another entity to generate that agronomic prescription plan based on the customer's data. The present inventive method and Improved Processor improved by and comprising the Agronomic Prescription Product does not warrant a catastrophic event. However, its implementation avoids the possibility of a total loss of the expected increase in yield thereby reducing the impact of what may otherwise be a catastrophic event.

### BRIEF DESCRIPTION OF THE DRAWINGS

FIG. 1 is a schematic providing an overview of the Agronomic Prescription Product

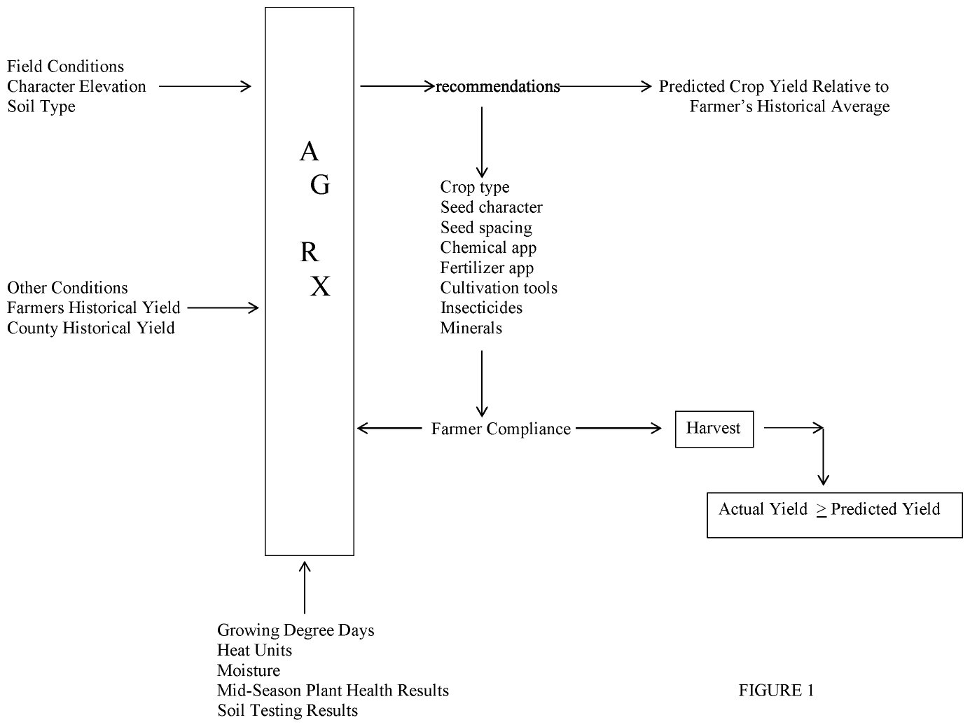

### DETAILED DESCRIPTION

The innovation disclosed herein provides, generally, an Improved Computer Processor (hereafter, Processor or Improved Processor) comprising an Agronomic Prescription Product that generates a guarantee on an increase in yield for a particular crop and plant type by field. The term “field” is used herein to indicate a specific geographically located area which may be expressed in terms of geospatial indicators and/or area units such as, but not limited to, acres, hectares, and square feet, and may also or alternatively be identified in plat books and/or by county, province, or other geographic area or geospatial measurement indicators. The guarantee on increase in yield is related to two historical yield measures (hereafter, the Agronomic Prescription Product). The first historical yield measure is the Customer's Historical Average and the second is the Historical County Yield. The Customer's Historical Average is the average of the Customer's actual historical crop yields (up to 10 years), on that field excluding any yield exclusion, yield adjustments and trend adjustments by crop types. Or, if this is the first year this Customer will grow on this field, then the Customer's Historical Average may take into account yields on other fields in the same general region he has farmed. The Customer must have production records of three years or more. For Customers with less than a minimum of seasons production records, or for any added land with no production records, 65% of the County Historical Average will be used to determine the Customer Historical Average. The Historical County Yield is an average of the historical yield of the county in which the Customer's field used for the Customer's Historical Average is located. The Improved Processor is enabled by the Agronomic Prescription Product to accept and process specific data and convert that data into agronomic prescription requirements and recommendations to enable the customer to comply with the requisites of the method. Specifically, the Improved Processor determines the difference between the Customer's Yield History and the County's Yield History, in percentage points. Then that percentage is used to compare the current year's production to Final County Yield (FCY) which is the average of all yields produced in the county as collected and calculated by a qualified county yield source, or another acceptable and qualified county yield measure.

Specific agronomic prescription recommendations related to seed, fertilizer, pesticides, crop protection (which is defined here as the collection of tools, products, and practices farmers use to defend their crops against weeds, insects, and disease, and includes pesticides, herbicides, insecticides, chemicals and fungicides plant health analysis, in-season micro-nutrient applications and other agronomic actions) are generated by the Processor improved by the Agronomic Prescription Product. These recommendations are combined by the Improved Processor to provide agronomic prescription recommendations for the purpose of increasing yield on a specified field. The recommendations generated by the computer improved by the Agronomic Prescription Product are the result of combining a large number of on-going data points for a particular crop and plant type by field and geographically specific field location (wherein “field” is a term used to designate a specific geographically located area). Specifically, the Processor comprises a novel model process embodying an Agronomic Prescription Product which is a process model that learns and improves the likelihood of yield increases through new data collection. In addition to variety identification, seed data, field maps and other standard field and cultivation information, the Processor embodying the Agronomic Prescription Product accepts and employs results of plant health analysis during one or more mid-season growing periods to benchmark and to convert plant health data and analyses into recommended agronomic prescription steps as needed to address, amend or improve upon any noted plant deficiencies and to reach a predicted yield level. Artificial Intelligence (AI) may be incorporated for the purpose of detecting and understanding data and generating agronomic prescription recommendations. The Agronomic Prescription Product further comprises functionality to cause the Improved Processor to create field maps overlaid by the recommended prescriptions associated with geographic coordinates for tailored and targeted application.

The novel agronomic prescription technology comprising the Agronomic Prescription Product improves the Processor thereby enabling the computer to take into account information about crop and plant type as well as field characteristics on a per acre or per geographic unit basis. Field characteristics may include, for example but without limitation, soil types which are mapped. Weather patterns and seasonal considerations may also be accounted. Based on that information and best agricultural practices as known in the art, the Improved Processor converts that data and generates cultivation, fertilizer, or other recommendations and/or recommended or accepted equipment lists for use in applying fertilizer, pesticides, crop protection chemicals, and seed planting at differing variable controlled rates according to the mapped field characteristics. Preferably, the Processor indicates appropriate timing and generates field locations (by coordinates) for these actions relative to the changing field and season conditions. Field, weather, crop, and plant conditions may be monitored throughout the growing season, and information related to said conditions may also be processed by the Processor relative to plants growing there. Mid-season plant health testing analyses (as known in the art), sampling data, and results are submitted to and taken into account by the Processor improved by the incorporation of the Agronomic Prescription Product which converts the data to recommendations pertaining to additional inputs or cultivation methods and tools. Specifically, the Processor may apply algorithms to employ the data to generate instructions related to; whether, where, and when to apply additional inputs and/or when or whether specific implements should be employed to adjust field conditions as required for optimal growth and production. The Processor improved by the Agronomic Prescription Product generates agronomic prescription recommendations based on the mid-season plant health analysis testing results and some or all of the aforementioned data. In a preferred embodiment, the Processor generates a field map on which is overlaid the various agronomic prescription recommendations and application rates, etc., per field coordinates.

Mid-season plant health analyses and, optionally, soil testing technology as used with the present agronomic prescription innovation is performed at specified growth stages of the crop or in response to an environmental event on the planted crop variety in the field or geographic unit. For example, growth stages of corn comprise vegetative (V) stages are identified by the number of collars present on the plant. These stages are labeled V1-VT roughly equal to about 6-8 weeks in total followed by reproductive growth stages. For example, at V1, round-tipped leaf on first collar appears. The tissue samples for corn varieties are typically taken during the growth stages from V3 to V5 or VT. The tissue samples for soybean varieties are usually collected during the R1 to R2 stages. Data resulting from these mid-season plant health analyses may be employed by the Processor to generate agronomic prescription recommendations.

The Improved Processor comprising the Agronomic Prescription Product generates a schedule of agronomic prescription recommendations, e.g., the schedule indicates when and which plant health analysis samples should be gathered relative to any one or all of the growing degree days, heat units, moisture, soil type, and other factors input into, detected by, or recorded by the Processor. The Improved Processor accepts results of plant health analysis sampling and soil testing results, and, employing the Agronomic Prescription Product, will analyze and take into account measurements pertaining to any one or more of the plants' and its surrounding soil's macronutrients. Macronutrients typically include, but are not necessarily limited to, one or more of nitrogen, phosphorus, and potassium. The analysis may also include measurements of micronutrients which include, but are not necessarily limited to one or more of sulfur, boron, zinc, magnesium, calcium, manganese and copper, seed type and source. The analysis may also include measurements for other chemicals applied including pest control products, and also fertilizers, and fungicides. In some embodiments, field weather data collection, large and small-scale weather data, satellite, soil probes and drone imagery, periodic crop reports, and other soil sampling and analysis, and on-going and real-time or uploaded field data provided by machinery or other sources may also be collected, analyzed and employed by the Processor. Some or all of this data is used by the Processor to create and generate geographically specific agronomic prescription recommendations both prior to planting and during the growing period, and, optionally, post-harvest and to generate field maps showing placement of the agronomic prescription recommendation for the recommended actions and applications. In embodiments the Improved Processor generates field maps showing the presence or absence of one or more of the field conditions, plant conditions, and plant type; and overlays recommended or planned application or completed application or herbicides, fertilizers, pesticides, nutrients, seed type on the field map, indicating compliance or noncompliance with the agronomic prescription recommendations generated by the Improved Computer.

The Agronomic Prescription Product employed by the Improved Computer Processor also may prescribe mid-season adjustments relative to changes detected in measurements of conditions and results received by the Processor improved by the Agronomic Prescription Product and its analysis of such changes. These mid-season adjustments may be in the form of new recommended or required actions resulting from the Processor's analysis of such changes. The Agronomic Prescription Product's Improved Processor comprises programming enabling it to accept multiple data points relative to many field and plant conditions, including plant health analysis results, and to employ those data points in accordance with programmed predictors and their relationships to plant growth and field location of the sample tested to generate the Agronomic Prescription Product's recommendations for growth or yield improvement, or generate recommendations for correction of field and crop conditions. Based on assumptions with which the operator will comply, the Processor combines various measurements of some or all of the previously mentioned factors, conditions, seed types, field additives, soil types, etc., and configures and generates a Crop Performance Guarantee on a portion of the Customer Historical Average yield for that field, provided or conditioned upon employment by the customer of a specified minimum of the agronomic prescription recommendations generated by the Improved Processor and provided to the Customer. The Customer's Historical Average is an average of that farmer/grower/Customer's actual historical crop yields, excluding yield exclusions, yield adjustments and trend adjustment by crop types over a specified number of growing seasons for a specific field or geographic area. Alternatively, 65% of the County Historical Average may be used. The County Historical Average is the USDA county historical Crop yield average for a given period of time, for example but not limited to, 10 years by crop types. The Crop Performance Guarantee as previously described comprises the Improved Processor or Improved Computer which enables the computer processor to generate recommendations or a “prescription” based on crop type, field type, soil conditions, and pest pressure in the field to increase yield by an amount related to historical yield and determined by the Improved Processor (herein referred to as the Crop Performance Guarantee). The Improved Processor generates agronomic prescription recommendations tailored to the purpose of increasing crop and plant type yield a certain amount relative to historical yield, along with a guaranteed increase related to the actual yield should that yield be lower than prescribed.

In a preferred embodiment, at least some of the data gathered by performing the novel method is specific to the crop and plant type by field while other data may be more widely applicable but is also considered. The data, whether field, seed, chemical, fertilizer, nutrient or fungicide-specific or more widely or a combination, and whether uploaded in near real-time or based on historic records, is used by the Processor to generate agronomic prescription recommendations related to products, tillage, practice and/or application all specifically tailored to the crop and plant type, and field location, for which the Customer's Historical Average applies.

Data may include field mapping data, input data, and plant date. Field mapping data describes soil type by zone and contour and may include tile placement or information indicating historically wet or dry portions and good or poor soil fertility. Data may also include records of field preparation, seed, chemical and fertilizer selection as well as records of application of chemicals (inputs) comprising nutrients, pesticides, crop protection chemicals, fungicides and fertilizers, and in some climates, irrigation. Preferably, the Improved Processor creates a field map and then generates and overlays the field mapping data on the field map, creating a visual representation of what has been done, what is recommended or both, all relative to field position. The data may include certain known field conditions such as low spots which may be wet, fence rows where weeds are more prevalent, as well as historic and near real-time or real-time conditional data such as temperature, wind speeds, weather, humidity and soil moisture, temperature and growing degree units. Data may include mapped historic yield records.

The agronomic prescription recommendations generated by the Processor improved by the Agronomic Prescription Product taking into account some or all of the field data, may include seed selection, seed spacing, field preparation methodology including fertilizer and field nutrient management, recommended planting dates, recommended planting rates tailored to the field mapping data, recommended applicator technology in addition to rates of application of nutrients, fertilizer, pesticides, crop protection chemicals, fungicides and recommended agronomic prescription products and practices such as tillage, irrigation and harvest protocols, all relative to field location.

Agronomic prescription recommendations are preferably generated by the Processor improved by the Agronomic Prescription Product both prior to and during a growing season on an ongoing and reactive basis taking into account changing conditions. The collected data is employed by the method to make planting, cultivation and harvesting location-specific recommendations for the ultimate purpose of increasing the operator's yield over and above previous yields and guaranteeing the crop performance on a portion of the Customer Historical Average for that field. In other words, a producer Customer will be incentivized to apply the prescribed recommendations at the prescribed field locations in exchange for the Yield Performance Guarantee which is related to an average of a given number of past years of Customer's Historical Average and the County Historical Average. More specifically, the Improved Processor is programmed by the Agronomic Prescription Product to consider the agronomic data and manipulate it on an ongoing basis to generate a series of prescriptions and specific locations in the field to which the prescription is to be applied. When these agronomic product prescriptions are followed, a yield increase is predicted, and that increase in yield qualifies for the Crop Performance Guarantee, decreasing the financial and yield risk that a grower would otherwise take on the investment required to increase yield which would require the customer to gather the data, and generate/devise its own recommended strategies to increase yield.

The present invention provides means for a customer to gain a guarantee on a portion of the expected increase in yield, should that yield not be gained. Specifically, when these Agronomic Prescription Product recommendations generated by the Improved Processor are followed and result in a yield increase at or above a predetermined yield level, then the customer markets as normal, collecting payment for the product sold. But, if the yield does not reach the predetermined yield level percentage of Customer's Historical Average, then the replacement cost of prescribed inputs and value of the guaranteed yield increase is paid. Without the Agronomic Prescription Product and Crop Performance Guarantee, the increase in yield as percentage of Customer's Historical Average (and the investment required to meet the prescription requirements) one would expect from applying other agronomic prescription products and methods, it could be a total loss of the Customer's investment in following or implementing an agronomic prescription in a catastrophic event. The present Improved Processor provides means for the customer to mitigate or guard against total loss and improves the likelihood of higher yields in non-catastrophic years.

The value of the Agronomic Prescription Product incorporated in the Improved Processor is contingent upon a number of interrelated factors, contingencies and dependencies. Specifically, the value relies on employment of the agronomic prescription recommendations based, at least in part, on field characteristics and location, seed, chemical and fertilizer data, for the Customer to receive the Crop Performance Guarantee. This increase may be expressed in any of a number of ways including per acre, per field, by crop quality, etc. The cost for the Agronomic Prescription Product and its yield increase guarantee (the Crop Performance Guarantee) are dictated by the crop and plant type, field location and agronomic prescription cost model. Any yield loss payable under the Agronomic Prescription Product will be paid for as a percentage of the full crop input replacement cost determined by the crop and plant type, and by the agronomic prescription cost model established in the Agronomic Prescription Product agreement. A qualifying underlying crop insurance policy includes a minimum coverage level and specified unit structure. Payment on performance is contingent upon certification by the customer and the guarantee provider of adherence to the Agronomic Prescription Product recommendations generated by the Improved Processor made for the customer's crops and fields and the retention of an underlying crop insurance policy for that field.

In practice, the Customer selects the crop and plant type and field for which he wishes to obtain the agronomic prescription. In most cases, the Customer will have recent soil field maps in hand and equipment necessary to employ agronomic prescription technology farming but, if not, then access to such information and equipment will be necessary. A number of data points (which may include but not be limited to field, seed, seed spacing, and crop characteristics (e.g. low spots that are not well tiled or certain varieties that require more nitrogen in the soil, etc., as described previously), a map of the field to which the prescription will be applied, weather data (both past, near real-time and predicted), soil and plant characteristics, past yields and varieties grown, and seed and chemical varieties and characteristics will be taken into account by the Improved Processor and at least one agronomic recommendation will be generated by the Improved Processor. Next, the customer selects crop inputs from the approved agronomic prescription list. Customer also purchases a qualifying underlying crop insurance policy having a requisite minimum data, coverage level and specific unit structure for that field. This data is used by the Improved Processor to benchmark the Agronomic Prescription Product performance. The customer may select the crop type and plant variety to be grown which will be taken into account by the Improved Processor when generating agronomic product or tillage recommendations, or, optionally, the recommendations generated by the Improved Processor may be made contingent on a required crop and plant variety determined by the Improved Processor comprising the Agronomic Prescription Product based on the field, crop and plant type characteristics. In any event, the field is prepared, and seed varieties are planted in accordance with the Agronomic Prescription Product and practice recommendations.

Over the growing season, data is continually gathered and/or monitored relative to plant, weather, rainfall, field moisture, wind speeds, and pest infestation information and input into the Improved Processor. Mid-season plant health analyses are required to test for any plant deficiencies. Plant health analyses recommendations are generated by the Improved Processor based on the plant data inputs, the variety of seed planted, crop protection applied, historic information about this field, weather, and pest data available relative to the field location from which plant samples are selected for testing. Any noted plant health deficiencies must be addressed with agronomic prescription recommendations generated by the Improved Processor and applied within the agronomic recommended time frames, also generated by the Processor improved by the Agronomic Prescription Product.

Agronomic recommendations and data related to Customer's Historical Yield as described herein may further include but are not limited to fertilizers and fertilizer application, macronutrients and micronutrients and their application, minerals and application of minerals, and application of any one or more of insecticides, pesticides, herbicides, fungicides, plant hormones, bactericides, viruses, water, chemicals, soils, cover crops, manure and the like.

Subject to the customer's compliance with the terms and conditions of the Agronomic Prescription Product agreement, if a pre-determined Crop Performance Benchmark is not obtained, the Agronomic Prescription Product will pay the Crop Performance Guarantee Payment as described below. However, the Crop Performance Guarantee will not cover any shortfalls in the Crop Performance caused by certain events, which are “Intervening Events”. Eligible Acres impacted by an Intervening Event (“Damaged Acres”) will be excluded from the Crop Performance and Crop Performance Payment (to be fully described herein) calculations. For example but not limitation, Intervening Events may include the customer's abandonment of the crops; fire; adulterated seed; damage from flood or backup water; wildlife or domesticated animals, tornados, replanted acres after a specified date, pollutants other than fertilizer, pesticide, or weed protectant specified and correctly applied, to name a few. Further, failure by the customer to materially follow and conform to the Agronomic Prescription Produce will also void the guarantee.

To provide a more detailed embodiment of the present invention, certain terms are employed as defined herein. However, these terms may be replaced by others similarly defined or defined to represent similar concepts:
The “Customer's Historical Average” is that average of the Customer's actual historical Crop yields (up to 10 years), excluding any yield exclusion, yield adjustments and trend adjustments by crop types. The Customer must have production records of three years or more. For Customers with less than a minimum of seasons production records, or for any added land with no production records, 65% of the County Historical Average will be used to determine the Customer Historical Average.
The “County Historical Average” is the USDA county historical Crop yield average for a given period of time, for example but not limited to 10 years by crop types.
The “Final Harvest Yield” is the average number of bushels per acre of the Crop and crop type grown by the Customer in the County in the crop year and harvested or appraised on or before December 1 of that year, as verified by the gross production as harvested or appraised for grain on the Customer's MPCI production reports prior to any adjustment for quality, but excluding any Damaged Acres or Reimbursed Acres (as defined below). Crop(s) may be adjusted for moisture on corn to a specified percentage and soybeans to a specified percentage or the % moisture accepted by the buyer without moisture discounts.
The “Final County Yield” is the average number of bushels per acre of the Crop and crop type grown by all producers in the County in the crop year, as reported by USDA NASS in April of the following calendar year.
The “Percentage Historical Difference” is the percentage difference between Customer Historical Average and County Historical Average used when the Final County Yield is lower than the Historical County Yield.
The “Eligible Acres” is the number of acres of the Crop and crop type planted by the Customer in the County and state for the crop year per the certified MPCI acreage reports which report takes into account and reports each crop type, plant date, and acres planted per crop type by county and is turned in to support the crop insurance policy.
The “Replacement Cost” is the per acre cost of the Agronomic Prescription Product and prescribed crop inputs per acre each crop type.
“Crop Performance Benchmark”. The system provides a warrant that the Agronomic Prescription Product will provide the Customer with a bushel yield increase calculated as follows:
“Crop Performance Coverage” If the Final County Yield is greater than or equal to the County Historical Average, then the Crop Performance Benchmark % ill be 80% or another specified percentage of the Customer's Historical Average in bushels per acre and crop type: and

If the Final County Yield is less than the County Historical Average, then the Crop Performance Benchmark will be calculated by multiplying the Customer's Historical Average in bushels per acre and crop type by (1) the percentage that the Final County Yield is of the County Historical Average (the “Final County Performance”) and (2) 80% or another specified percentage.

### EXAMPLES

Preferred Crop Performance Payment Formula

If the Final County Yield is equal to or higher than the County Historical Average and the customer employing the Agronomic Prescription Product does not meet the Crop Performance Benchmark described above, then the computer Processor improved by the Agronomic Prescription Product calculates a payment for the Customer equal to the Crop Performance Payment calculated as outlined in the following steps:
1) Crop Performance Benchmark=(Customer Historical Average*Crop Performance Coverage)
2) Crop Performance Trigger=(Final Harvest Yield<Crop Performance Benchmark)
3) Crop Performance Payment=Replacement Cost
   provided, however, that the Crop Performance Payment shall not exceed a specified per acre amount for Corn and Soybeans.

### Hypothetical Corn Example 1

Assume that the Final County Yield is equal to or higher than the County Historical Average, and the Customer's Historical Average is 200 bushels/acre and the Final Harvest Yield is 159 bushels/acre, the Crop Performance Benchmark is 160 bushels/acre and the Replacement Cost for corn is $18. The Crop Performance Payment owed to such Customer would be $18 per acre.

| | |
|---|---|
| County Historical Average: | 185 bushels |
| Final County Yield: | 185 bushels |
| Customer Historical Average: | 200 bushels |
| Final Harvest Yield: | 159 bushels |
| Crop Performance Coverage: | 80% |
| Replacement Cost: | $18 |
| 1) Crop Performance Benchmark: | 200 bushels * 80% = 160 bushels |
| 2) Crop Performance Trigger: | 159 < 160 |
| 3) Crop Performance Payment: | $18 per acre |

If the Final County Yield is lower than the County Historical Average and the Agronomic Prescription Product does not meet the Crop Performance Benchmark described above, then the system shall pay the Customer/farmer the Crop Performance Payment calculated as outlined in the following steps:
1) Final County Performance=(Final County Yield/County Historical Average)
2) Crop Performance Benchmark=(Customer Historical Average*Final County Performance*Crop Performance Coverage)
3) Crop Performance Trigger=(Final Harvest Yield<Crop Performance Benchmark)
4) Crop Performance Payment=Replacement Cost
   provided, however, that the Crop Performance Payment shall not exceed a specified limit per acre for Corn and Soybeans. In the example, the specified limit=$18.

### Hypothetical Corn Example 2

Assume that the Final County Yield is 184 bushels, which is lower than the County Historical Average of 185 bushels/acre, and the Final Harvest Yield is 158 bushels/acre, the Crop Performance Benchmark is 159 bushels/acre, and the Replacement Cost for corn ($18)/acre. The Crop Performance Payment owed to such farmer would be $24 per acre.

| | |
|---|---|
| County Historical Average: | 185 bushels |
| Final County Yield: | 184 bushels |
| Customer Historical Average: | 200 bushels |
| Final Harvest Yield: | 159 bushels |
| Crop Performance Coverage: | 80% |
| Replacement Cost: | $18 |
| 1) Final County Performance: | 184/185 bushels = 99.5% |
| 2) Crop Performance Benchmark: | 200 bushels * 99.5% * 80% = |
| | 159.2 bushels |
| 3) Crop Performance Trigger: | 159 < 159.2 |
| 4) Crop Performance Payments: | =$18 per acre |

1. A computer processor improved by incorporation of an Agronomic Prescription Product enabling the Improved Processor to generate a guarantee product for a crop yield percentage increase said guarantee product contingent at least on a difference between a Customer's Historical Average, and a County Historical Average, said guarantee product to cover a percentage of Farmer's Historical Average in a designated geographic area accounting for one or more of crop type, field characteristics, field map data, soil test results, pest infestation information and weather, the guarantee product comprising at least one recommendation based on said accounting, said at least one recommendation comprising any one or more of crop type, seed characteristics, seed spacing, chemical application, fertilizer application, cultivation methods, cultivation tools, chemical application, and fertilizer applications, said Agronomic Prescription Product further enabling the Improved Processor to configure the guarantee product to include a guaranteed crop yield performance percentage increase dependent on a measurement of difference between the Customer's Historical Average and the County Historical Average.

2. The Improved Processor of claim 1 each of said at least one recommendation further including one or both of relevant timing and field location for performance of said generated recommendation.

3. The Improved Processor of claim 1 wherein said at least one recommendation may comprise one or more of mid-season plant health analysis and soil testing.

4. The Improved Processor of claim 2 said at least one recommendation including mid-season plant health analysis and soil testing.

5. The Improved Processor of claim 3, the Agronomic Prescription Product further enabling said Processor to record and take into account at least one or more of growing degree days, heat units, moisture and soil type to generate said recommendations.

6. The Improved Processor of claim 5 wherein said recommendations comprise an indication of when and where said analyses and testing should be performed, said Processor generating field maps bearing indicators accordingly.

7. A product comprising a plurality of agronomic prescription recommendations for the purpose of increasing crop and plant type yield a certain amount in a designated geographic area, and a guaranteed increase related to an actual yield (Crop Performance Guarantee), said product comprising a computer processor improved by an Agronomic Prescription Product to accept multiple data points related to one or more of crop, soil, and crop tissue sampling in the designated geographic area and generate said agronomic prescription recommendations required to be performed on the designated geographic area to qualify for a yield increase guarantee relative to the Historical Average in the designated geographic area, wherein a Crop Performance Guarantee is determined by the computer processor's receipt of confirmation of implementation of one or more of the recommendations generated by the prescription product.

8. The product of claim 7, said computer processor further improved to receive confirmation of compliance with seed, chemical and/or fertilizer agronomic prescription recommendations.

9. The product of claim 7, said computer processor further improved to receive confirmation of compliance with mid-season plant tissue testing and/or physical soil treatment methods along with said data points.

10. The Agronomic Prescription Product of claim 1, wherein generating said one or more recommendations further comprises receipt of confirmation of compliance with chemical soil treatment methods.

11. A computer processor improved by an Agronomic Prescription Product enabling the processor to generate a plurality of recommendations for the purpose of: increasing crop and plant type yield a certain amount, said Improved Processor calculating an expected yield based on compliance with the recommendations and, upon receiving confirmation of compliance, said Improved Processor generating a guaranteed increase related to an actual yield.

12. A guarantee product to cover crop yield percentage of Customer's Historical Average in a designated geographic area, payment of crop yield performance under said Agronomic Prescription Product contingent upon receipt of confirmation of use of the Agronomic Prescription Product to comply with at least one selected from the group of: at least one field preparation recommendation, at least one seed selection recommendation, at least one crop fertilizer recommendation, at least one mid-season plant health analysis sampling recommendation, at least one pest control recommendation, at least one crop protection chemical, and/or at least one field conditioning recommendation.

13. A method of guaranteeing a crop yield performance percentage increase over the percentage difference between the Customer's Historical Average and the County Historical Average for the county in which the crop is grown, wherein payment of guarantee is contingent upon receipt of confirmation of compliance with at least one of a plurality of agronomic recommendations.

14. The method of claim 7, wherein said method comprises compilation of geographic area maps and at least one factor selected from the group of past yield data, past pest data, predicted pest data, past weather data, predicted weather data, current pest data, chemical protection and/or seed data to generate said plurality of recommendations.

15. The method of claim 8, wherein said plurality of recommendations comprises applying a fertilizer in accordance with said geographic area maps using variable rate technology.

16. The method of claim 8, wherein said plurality of recommendations comprises applying a crop protection chemical in accordance with said geographic area maps using variable rate technology.

17. The method of claim 8, wherein said plurality of recommendations comprises a seed variety.

18. The method of claim 8, wherein said plurality of recommendations comprises a mid-season plant health analysis.

19. The method of claim 8, wherein said plurality of recommendations comprises a chemical variety.

20. The method of claim 7, wherein the crop is selected from a grain, oilseed, fiber, cotton, corn, soybeans, wheat, rice, barley, oats, flax, vegetables, fruit, edible plants, inedible plants, food crops and the like.

21. The product of claim 5 wherein said at least one crop fertilizer recommendation is selected from the group comprising the macronutrients potassium, phosphate, and nitrogen.

22. The product of claim 5 further comprising at least one micronutrient recommendation selected from the group comprising sulfur, boron, zinc, magnesium, calcium, manganese and copper.

23. A method of guaranteeing a crop performance said guarantee dependent upon an increase over the percentage difference between producer Customer's Historical Average and County Historical Average.
